(19) United States
(12) Patent Application Publication
(10) Pub. No.: US 2024/0173203 A1
(43) Pub. Date: May 30, 2024

(54) PORTABLE VIBRATION DEVICE AND METHOD FOR MANUFACTURING THE SAME

(71) Applicant: SHENZHENSHI WEIWEIMA TECHNOLOGY CO.,LTD, Shenzhen (CN)

(72) Inventor: RUYI CAO, Shenzhen (CN)

(21) Appl. No.: 18/229,200

(22) Filed: Aug. 2, 2023

(30) Foreign Application Priority Data
Nov. 28, 2022 (CN) 202223185687.X

(51) Int. Cl. A61H 19/00

(52) U.S. Cl. CPC A61H 19/44; A61H 19/32; A61H 2201/0111; A61H 2201/5025

(57) ABSTRACT

The present disclosure provides a portable vibration device, the portable vibration device includes a vibration member that vibrates when energized; a controller electrically connected to the vibration member and configured to control a vibration of the vibration member; a power supply member electrically connected to the vibration member and the controller, and configured for supplying power to the vibration member and the controller; and a soft housing integrally formed and sealed to wrap the vibration member, the controller and the power supply member.

### CROSS-REFERENCE TO RELATED APPLICATIONS

This application claims the benefit of priority to Chinese Patent Application Number 202223185687.X filed on Nov. 28, 2022, in the China National Intellectual Property Administration. The entire contents of the above-identified application are hereby incorporated by reference.

### TECHNICAL FIELD

The disclosure relates to the technical field of massagers, and in particular to a portable vibration device and a method of manufacturing the portable vibration device.

### BACKGROUND

With the development and improvement of the society, people's living standards have significantly improved, and people are also increasingly concerned about the quality of sexual life. In order to meet people's sexual needs, there are many kinds of massagers to meet the needs of different parts of different genders.

In order to achieve a better massaging effect, a vibrator is usually set in the massager to massage different parts of the user through the vibration of the vibrator, and the massager needs to be cleaned after use to ensure the cleanness and hygiene during use. At present, some massagers sold in the market cannot be directly cleaned due to poor sealing performance, resulting in inconvenient use.

### SUMMARY OF INVENTION

The present disclosure has been made in view of the above problem, and provides a portable vibration device having excellent sealing performance such as water proofing and dust proofing.

To solve the above technical problems, the present disclosure provides a portable vibration device comprising: a vibration member; a controller electrically connected to the vibration member and configured to control vibration of the vibration member; a power supply member electrically connected to the vibration member and the controller, and configured for supplying power to the vibration member and the controller; and a soft housing integrally formed and directly sealed to wrap the vibration member, the controller and the power supply member.

Preferably, the soft housing is a soft rubber soft housing made of a silicone material.

Preferably, the portable vibration device further comprises a vibrating end and a mild vibration end, the vibrating end is an end close to the vibration member, and the mild vibration end is an end far away from the vibration member, the vibrating end is capable of vibrating with vibration of the vibration member.

Preferably, the portable vibration device further comprises a massage portion, the massage portion is arranged at one side of the vibrating end away from the mild vibration end, and the massage portion is a bullet shaped.

Preferably, a first receiving cavity, a second receiving cavity and a third receiving cavity are defined in the soft housing, the first receiving cavity, the second receiving cavity and the third receiving cavity are sequentially arranged in a longitudinal direction of the portable vibration device, and are respectively configured for receiving the vibration member, the power supply member and the controller, a first partition wall is located between the first receiving cavity and the second receiving cavity, and a second partition wall is located between the second receiving cavity and the third receiving cavity, and the first partition wall and the second partition wall are defined and formed by parts of the soft housing.

Preferably, the portable vibration device further comprises a fourth receiving cavity arranged adjacent to the third receiving cavity, and the fourth receiving cavity and the third receiving cavity are arranged in the longitudinal direction of the portable vibration device.

Preferably, the portable vibration device comprises a fourth receiving cavity arranged adjacent to the second receiving cavity, and the fourth receiving cavity and the second receiving cavity are arranged in a direction perpendicular to the longitudinal direction of the portable vibration device.

To solve the above technical problems, the present disclosure provides a portable vibration device comprising: an internal functional system configured to achieve basic functions of the portable vibration device, the internal functional system includes various internal functional elements which at least including a vibration member to generate required vibration and a controller system for generating and providing power signals and control signals to control the vibration member; and a soft hosing integrally formed and directly sealed to wrap all elements of the internal functional system.

Preferably, the controller system at least comprises: a controller electrically connected to the vibration member and configured to control vibration of the vibration member; and a power supply member electrically connected to the vibration member and the controller and configured for supplying power to the vibration member and the controller.

Preferably, the portable vibration device comprises a vibrating end and a mild vibration end, the vibrating end is an end close to the vibration member, and the mild vibration end is an end far away from the vibration member, the vibrating end is capable of vibrating following with the vibration of the vibration member.

Preferably, a first receiving portion configured for receiving the vibration member and a second receiving portion configured for receiving the internal functional system are defined in the soft housing, the first receiving portion, the first receiving portion is closer to the mild vibration end of the portable vibration device compared to the second receiving portion.

Preferably, the soft housing further comprises at least one partition wall integrated with the other portions of the soft housing.

Preferably, the second receiving portion of the soft housing comprises multiple sub cavities for accommodating various internal functional elements, and the partition wall is located between different sub cavities.

Preferably, the soft housing is a soft rubber soft housing made of a silicone material.

To solve the above technical problems, the present disclosure provides a method of manufacturing the portable vibration device as described above, the method comprises: providing a first mold and a second mold; heating the first mold to a certain temperature; injecting a first liquid silicone material into the first mold; placing the second mold cover on the first mold; injecting a second liquid silicone material into the second mold, making the second liquid silicone material to mix together with the first liquid silicone material, and then curing the mixture of the first silicone material and the second silicone material, so as to form the soft housing.

Preferably, the certain temperature is in a range of 75-85° C.

Preferably, the material of the first liquid silicone material is the same as that of the second liquid silicone material.

Compared with the prior art, the portable vibration device provided in the present embodiment, since the soft housing is integrally formed and encloses the vibration member, the power supply member, the controller and the circuit board, can effectively prevent water and dust from entering the soft housing, and can effectively improve the sealing performance without additionally arranging the sealing element, thereby reducing the manufacturing process.

### BRIEF DESCRIPTION OF DRAWINGS

Implementations of the present disclosure will now be described, by way of embodiment, with reference to the attached figures.

FIG. 1 is a three-dimensional structure diagram of a portable vibration device according to a first embodiment of the present disclosure.

FIG. 2 is an exploded view of the portable vibration device shown in FIG. 1.

FIG. 3 is a sectional view of the portable vibration device shown in FIG. 1.

FIG. 4 is a three-dimensional structure diagram of a portable vibration device according to a second embodiment of the present disclosure.

FIG. 5 is an exploded view of the portable vibration device shown in FIG. 4.

FIG. 6 is a sectional view of the portable vibration device shown in FIG. 4.

FIG. 7 is a flowchart illustrating a method for manufacturing the portable vibration device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”, specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references may mean “at least one”.

### First Embodiment

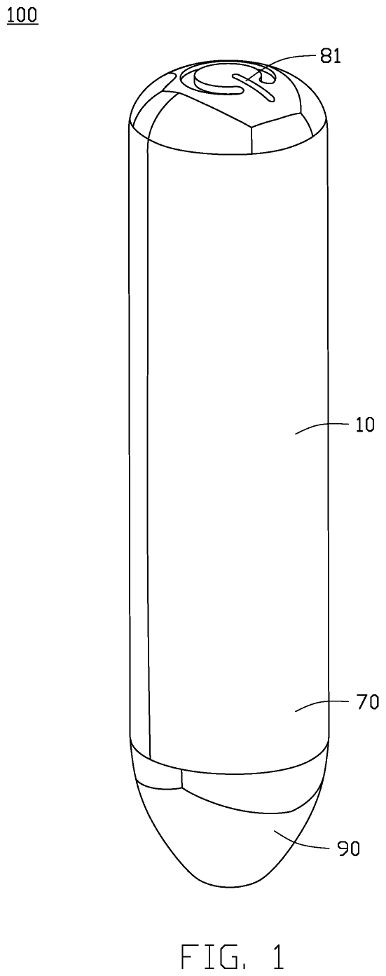

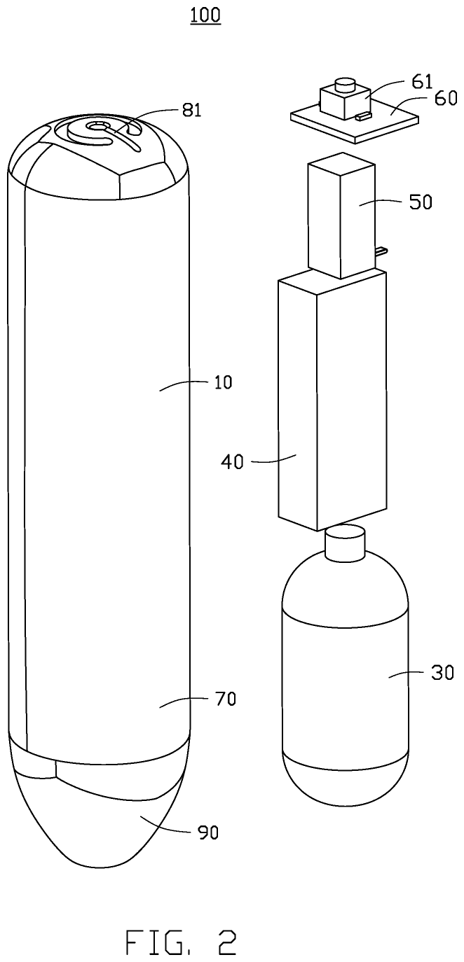

A portable vibration device according to a first embodiment of the present disclosure will be described below with reference to FIGS. 1 to 3.

Referring to FIGS. 1 to 3, the present disclosure provides a portable vibration device 100, the portable vibration device 100 comprises an internal functional system (not labeled) configured to achieve basic functions of the portable vibration device 100 and a soft housing 10 integrally formed and directly sealed to wrap the whole element of the internal functional system. The internal functional system includes various internal functional elements which at least comprise a vibration member 30 to generate the required vibration and a controller system 300 for generating and providing power signals and control signals to control the vibration member 30. The vibration member 30 and the controller system 300 are all accommodated in the soft housing 10.

The vibration member 30 is configured to generate the required vibration and at least a part of the portable vibration device 100 is in the female vagina when it is used, the vibration member 30 vibrates when it is energized, and at least a part of the whole portable vibration device 100 vibrates under the drive of the vibration member 30. In this way, the user can obtain a strong sense of pleasure in a short period of time physiologically and meet their sexual requirements. The vibration member 30 preferably includes an eccentric wheel (not labeled).

The controller system 300 comprises a power supply member 40, a controller 50, and a circuit board 60. The controller 50 is electrically connected to the vibration member 30 via the circuit board 60, and is configured for controlling a vibration of the vibration member 30.

The power supply member 40 is electrically connected to the vibration member 30 and the controller 50 via the circuit board 60, and is configured to supply power to the vibration member 30 and the controller 50.

In the present embodiment, the power supply member 40 is a disposable battery, and thus the battery does not need to be charged, which is convenient for users to use. Further, the power supply member 40 is not removable in the soft housing 10, and the service life is more than 150 minutes. Alternatively, the power supply member 40 can be for example a wireless charging battery.

The soft housing 10 can be for example formed from silica gel material by a rubber coating process of liquid silicone rubber, so as to wrap the vibration member 30, the power supply member 40, the controller 50, and the circuit board 60, and seal these internal functional elements inside the soft housing 10.

Because the soft housing 10 is integrally formed and sealed to wrap the vibration member 30, the power supply member 40, the controller 50, and the circuit board 60, it can effectively prevent water and dust from entering the soft housing 10, and can effectively improve a sealing performance without additional sealing elements, so that the assembly process can be reduced.

In addition, the silica gel material is skin friendly, the soft housing 10 can be in gently contact with the human body during use, so that the users feel more comfortable.

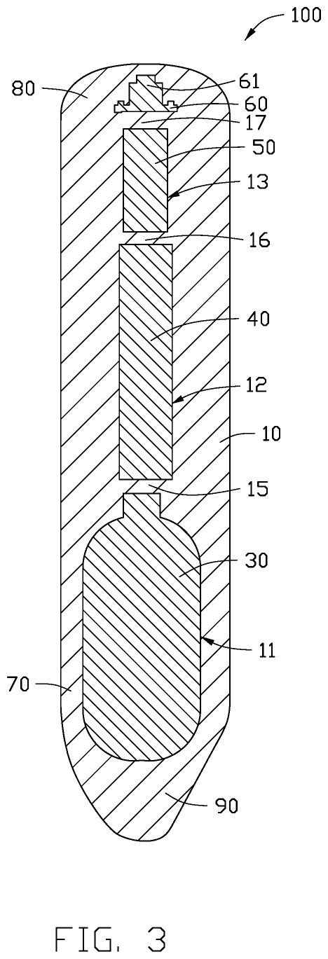

Furthermore, referring to FIG. 3, the soft housing 10 is formed with at least a first receiving cavity 11 (that is a first receiving portion), a second receiving cavity 12 (a multiple sub cavity of a second receiving portion), a third receiving cavity 13 (a multiple sub cavity of the second receiving portion) and a fourth receiving cavity 14 (a multiple sub cavity of the second receiving portion). The first receiving cavity 11, the second receiving cavity 12, the third receiving cavity 13 and the fourth receiving cavity 14 are configured for receiving the vibration member 30, the power supply member 40, the controller 50 and the circuit board 60 respectively, and these cavities are sequentially arranged in a longitudinal direction of the portable vibration device 100, the longitudinal direction defines a first direction.

A first partition wall 15 disposed between the first receiving cavity 11 and the second receiving cavity 12, a second partition wall 16 disposed between the second receiving cavity 12 and the third receiving cavity 13, and a third partition wall 17 disposed between the third receiving cavity 13 and the fourth receiving cavity 14 are defined and formed by parts of the soft housing 10 so as to separate two adjacent reception cavities. In addition, the first partition wall 15, the second partition wall 16 and the third partition wall 17 are all integrally formed with the soft housing 10, and therefore the first partition wall 15, the second partition wall 16 and the third partition wall 17 cooperate with the soft housing 10 to enclose each internal functional elements including the vibration member 30, the power supply member 40, the controller 50 and the circuit board 60, of the internal functional system, so that various surfaces of these internal functional elements are respectively in close contact with the soft housing 10, the first partition wall 15, the second partition wall 16 and the third partition wall 17.

Furthermore, the soft housing 10 not only provides good sealing performance, but also improves anti-falling shocking ability of the portable vibration device 100. In addition, other mounting structures are not required to fix the vibration member 30, the power supply member 40, the controller 50, and the circuit board 60, the portable vibration device 100 has a simple mechanical structure and its assembly process is simple.

In addition, the portable vibration device further comprises a holding portion adjacent to the fourth receiving cavity 14, due to the arrangement of the first partition wall 15, the second partition wall 16 and the third partition wall 17, the vibration of the vibration member 30 cannot be transmitted to the fourth receiving cavity 14, when the user holds the holding portion, only slight vibrations can be felt, and even no vibrations can be felt, and therefore a situation of the head and tail caused by the vibration of the holding portion does not occur, which will be described in detail below.

The portable vibration device 100 further comprises a vibrating end 70 adjacent to the vibration member 30 and a mild vibration end 80 far away from the vibration member 30, the power supply member 40, the controller 50, and the circuit board 60 described above. When power is supplied, the vibrating end 70 starts to vibrate, and the mild vibration end 80 does not vibrate following with the vibration of the vibration member 30. The mild vibration end 80 can be understood as being able to feel slight vibrations or not being able to feel vibrations.

In this embodiment, the vibration member 30 comprises a motor (e.g. Motor N20 Model motor), and the working current is set to not exceed 160 mA, the soft housing 10 of the portable vibration device 100 is made of soft material, when in use, one end of the vibration member 30 can obviously feel the vibration, while the end far away from the vibration member 30, that is the mild vibration end 80, is not affected by the vibration member 30. In this way, the user has a better experience when in use.

The portable vibration device 100 further comprises a massage end 90. The massage portion 90 is arranged at a side of the vibrating end 70 away from the mild vibration end 80. The massage portion 90 is bullet shaped. The massage portion 90 and the vibrating end 70 will also vibrate together when in use. Since the massage portion 90 is bullet shaped, the user can also accurately massage a certain part according to needs, so that the experience is better.

Alternatively, at least a part of the massage portion 90 is a plane. In this way, the user can selectively use the plane to massage a certain part according to requirements, so that the experience is better.

Furthermore, the control system further comprises a switch 61 arranged on the circuit board 60 for cooperating with a switching flag 81 to control the portable vibration device 100 to be switched on or switched off. In the present embodiment, the switch 61 is provided at an end face of the mild vibration end 80 of the portable vibration device 100.

The switch flag 81 is located on an end face of the mild vibration end 80 of the portable vibration device 100 and serves as a user interface to easily operate by the user. The switch flag 81 is aligned with a position of the switch 61.

Alternatively, the mild vibration end 80 may be provided with other patterns to improve an aesthetic appearance, which is not limited herein.

Compared with the prior art, the portable vibration device 100 provided in the present embodiment, since the soft housing 10 is integrally formed and encloses the vibration member 30, the power supply member 40, the controller 50 and the circuit board 60, can effectively prevent water and dust from entering the soft housing 10, and can effectively improve the sealing performance without additionally arranging the sealing element, thereby reducing the manufacturing process.

### Second Embodiment

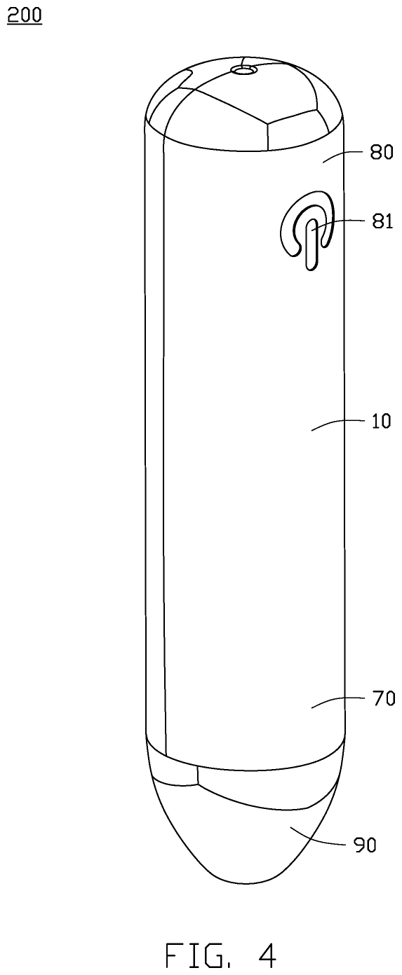

A portable vibration device according to a second embodiment of the present disclosure will be described below with reference to FIGS. 4 to 6. Note that, for convenience of description, members having the same functions as those of the members described in the above-described embodiment are denoted by the same reference numerals, and description thereof is omitted.

The portable vibration device 200 of the second embodiment differs from the portable vibration device 100 of the first embodiment only in that an arrangement position of the circuit board 60 is different, and other structures are the same as those of the portable vibration device 100 of the first embodiment and will not be described in detail here.

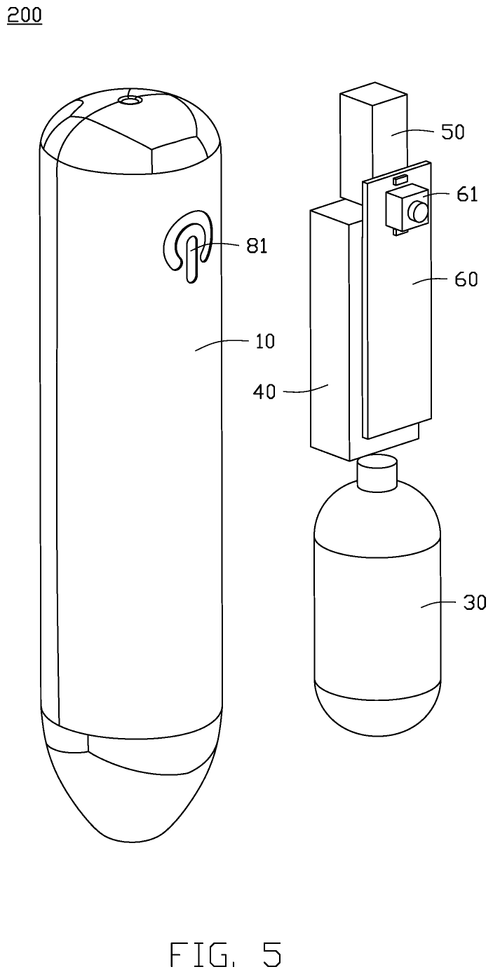

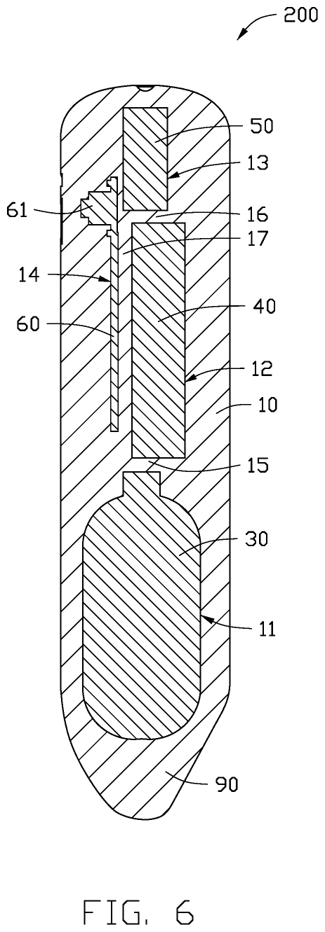

As shown in FIGS. 5-6, the soft housing 10 is formed with at least a first receiving cavity 11, a second receiving cavity 12, a third receiving cavity 13 and a fourth receiving cavity 14. The first receiving cavity 11, the second receiving cavity 12, the third receiving cavity 13 and the fourth receiving cavity 14 are used for receiving the vibration member 30, the power supply member 40, the controller 50 and the circuit board 60 respectively. The first receiving cavity 11, the second receiving cavity 12 and the third receiving cavity 13 are arranged successively in the longitudinal direction of the portable vibration device 100. In addition, the second receiving cavity 12, the third receiving cavity 13 and the fourth receiving cavity 14 are arranged in a direction perpendicular to the axial direction of the portable vibration device 100.

In addition, a first partition wall 15 disposed between the first receiving cavity 11 and the second receiving cavity 12, a second partition wall 16 disposed between the second receiving cavity 12 and the third receiving cavity 13, and a third partition wall 17 disposed between the third receiving cavity 13 and the fourth receiving cavity 14 are defined and formed by parts of the soft housing 10, so as to separate two adjacent reception cavities. In addition, the first partition wall 15, the second partition wall 16 and the third partition wall 17 are all integrally formed with the soft housing 10. In this way, the first partition wall 15, the second partition wall 16 and the third partition wall 17 cooperate with the soft housing 10 to enclose each internal functional elements including the vibration member 30, the power supply member 40, the controller 50 and the circuit board 60, of the internal functional system. So that various surfaces of these internal functional elements are respectively in close contact with the soft housing 10, the first partition wall 15, the second partition wall 16 and the third partition wall 17. Therefore, the sealing performance can be improved, and the effect of anti-falling shock can be achieved.

Furthermore, the control system further comprises a switch 61 arranged on the circuit board 60 for cooperating with a switching flag 81 to control the portable vibration device 100 to be switched on or switched off. In the present embodiment, the switch 61 is provided on the side of the mild vibration end 80 of the portable vibration device 100.

Further, referring to FIGS. 4 and 5, the switch flag 81 is located on a side surface of the mild vibration end 80 of the portable vibration device 100 and serves as a user interface to easily operate by the user. The switch flag 81 is aligned with a position of the switch 61. Alternatively, the mild vibration end 80 may be provided with other patterns to improve an aesthetic appearance, which is not limited herein.

Compared with the prior art, the portable vibration device 200 provided in the present embodiment, since the soft housing 10 is integrally formed and encloses the vibration member 30, the power supply member 40, the controller 50 and the circuit board 60, can effectively prevent water and dust from entering the soft housing 10, and can effectively improve the sealing performance without additionally arranging the sealing element, thereby reducing the manufacturing process.

In addition, the present disclosure can be configured by freely combining the embodiments shown above within the scope of the invention of each claim, or by appropriately modifying each embodiment or omitting a part thereof.

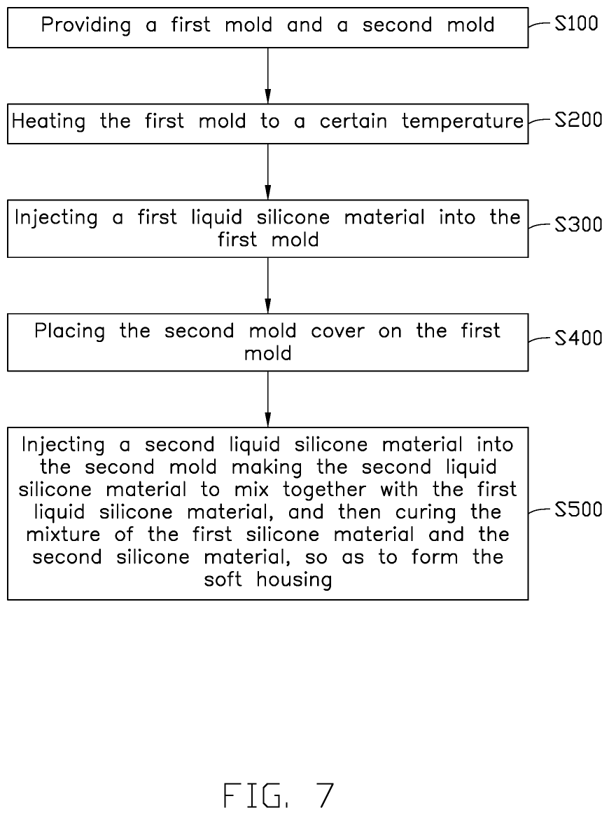

Referring to FIG. 7, the present disclosure further provides a method of manufacturing the portable vibration device as described above, the method comprises:
Step 100, providing a first mold and a second mold;
Step 200, heating the first mold to a certain temperature;
Step 300, injecting a first liquid silicone material into the first mold;
Step 400, placing the second mold cover on the first mold;
Step 500, injecting a second liquid silicone material into the second mold making the second liquid silicone material to mix together with the first liquid silicone material, and then curing the mixture of the first silicone material and the second silicone material, so as to form the soft housing.

In this embodiment, the material of the first liquid silicone material is the same as that of the second liquid silicone material. Alternatively, the material of the first liquid silicone material can also be different from that of the second liquid silicone material.

In addition, the certain temperature is in a range of 75-85° C., so that the first liquid silicone material can remain in a liquid state, thereby fusing with the second liquid silicone material. In this way, the first liquid silicone material and the second liquid silicone material can be quickly cured and solidified to form an integrated soft hosing which directly sealed to wrap the whole element of the internal functional system.

The scope of the present disclosure is defined by the terms of the claims, rather than the foregoing description, and thus it is intended that the embodiments described in this description be construed as illustrative only and not in a limiting sense. Accordingly, all changes that do not depart from the scope and boundaries of the claims, and equivalents to the scope and boundaries of the claims, are intended to be embraced therein.

What is claimed is:

1. A portable vibration device comprising:
a vibration member;
a controller electrically connected to the vibration member and configured to control vibration of the vibration member;
a power supply member electrically connected to the vibration member and the controller, and configured for supplying power to the vibration member and the controller; and
a soft housing integrally formed and directly sealed to wrap the vibration member, the controller and the power supply member.

2. The portable vibration device according to claim 1, wherein the soft housing is a soft rubber soft housing made of a silicone material.

3. The portable vibration device according to claim 1, further comprising a vibrating end and a mild vibration end, the vibrating end is an end close to the vibration member, and the mild vibration end is an end far away from the vibration member, the vibrating end is capable of vibrating with vibration of the vibration member.

4. The portable vibration device according to claim 3, further comprising a massage portion, the massage portion is arranged at one side of the vibrating end away from the mild vibration end, and the massage portion is a bullet shaped.

5. The portable vibration device according to claim 1, wherein a first receiving cavity, a second receiving cavity, and a third receiving cavity are defined in the soft housing, the first receiving cavity, the second receiving cavity, and the third receiving cavity are sequentially arranged in a longitudinal direction of the portable vibration device, and are respectively configured for receiving the vibration member, the power supply member, and the controller;
a first partition wall is located between the first receiving cavity and the second receiving cavity, and a second partition wall is located between the second receiving cavity and the third receiving cavity, and the first partition wall and the second partition wall are defined and formed by parts of the soft housing.

6. The portable vibration device according to claim 5, wherein a fourth receiving cavity is arranged adjacent to the third receiving cavity, and the fourth receiving cavity and the third receiving cavity are arranged in the longitudinal direction of the portable vibration device.

7. The portable vibration device according to claim 5, wherein a fourth receiving cavity is arranged adjacent to the second receiving cavity, and the fourth receiving cavity and the second receiving cavity are arranged in a direction perpendicular to the longitudinal direction of the portable vibration device.

8. A portable vibration device comprising:
an internal functional system configured to achieve basic functions of the portable vibration device, the internal functional system includes various internal functional elements which at least including a vibration member to generate required vibration and a controller system for generating and providing power signals and control signals to control the vibration member;
and a soft hosing integrally formed and directly sealed to wrap all elements of the internal functional system.

9. The portable vibration device according to claim 8, wherein the controller system at least comprises:
a controller electrically connected to the vibration member and configured to control vibration of the vibration member; and
a power supply member electrically connected to the vibration member and the controller and configured for supplying power to the vibration member and the controller.

10. The portable vibration device according to claim 8, wherein the portable vibration device comprises a vibrating end and a mild vibration end, the vibrating end is an end close to the vibration member, and the mild vibration end is an end far away from the vibration member,
the vibrating end is capable of vibrating following with the vibration of the vibration member.

11. The portable vibration device according to claim 10, wherein a first receiving portion configured for receiving the vibration member and a second receiving portion configured for receiving the internal functional system are defined in the soft housing, the first receiving portion, the first receiving portion is closer to the mild vibration end of the portable vibration device compared to the second receiving portion.

12. The portable vibration device according to claim 11, wherein the soft housing further comprises at least one partition wall integrated with the other portions of the soft housing.

13. The portable vibration device according to claim 12, wherein the second receiving portion of the soft housing comprises multiple sub cavities for accommodating various internal functional elements, and the partition wall is located between different sub cavities.

14. The portable vibration device according to claim 11, wherein the soft housing is a soft rubber soft housing made of a silicone material.

15. A method of manufacturing the portable vibration device as claimed in claim 8, wherein the method comprises:
providing a first mold and a second mold;
heating the first mold to a certain temperature;
injecting a first liquid silicone material into the first mold;
placing the second mold cover on the first mold;
injecting a second liquid silicone material into the second mold, making the second liquid silicone material to mix together with the first liquid silicone material, and then curing a mixture of the first silicone material and the second silicone material, so as to form the soft housing.

16. A method of manufacturing the portable vibration device according to claim 15, wherein the certain temperature is in a range of 75-85° C.

17. A method of manufacturing the portable vibration device according to claim 15, wherein a material of the first liquid silicone material is the same as that of the second liquid silicone material.
